(19) United States
(12) Patent Application Publication
(10) Pub. No.: US 2026/0266369 A1
(43) Pub. Date: Sep. 10, 2026

(54) SHIFT FORK ACTUATOR

(71) Applicant: Schaeffler Technologies AG & Co. KG, Herzogenaurach (DE)

(72) Inventor: Reiner Neukum, Offenburg (DE)

(73) Assignee: Schaeffler Technologies AG & Co. KG, Herzogenaurach (DE)

(21) Appl. No.: 19/489,262

(22) PCT Filed: May 14, 2024
(86) PCT No.: PCT/DE2024/100432

§ 371 Date: Dec. 1, 2025

(30) Foreign Application Priority Data
Jun. 2, 2023 (DE) 10 2023 114 556.8

(51) Int. Cl. F16H 63/04; F16H 61/28; F16H 61/32; F16H 63/30; F16H 63/32

(52) U.S. Cl. CPC F16H 63/04; F16H 61/32; F16H 63/304; F16H 63/32; F16H 2061/2884; F16H 2063/3063; F16H 2063/321

(57) ABSTRACT

A shift fork actuator includes an actuator housing, a drive motor provided in the actuator housing, and a linear drive driven by the drive motor. The linear drive includes a drive shaft, a driven drive spindle integral with the drive shaft, and an actuating element. The actuating element is linearly moveable and linearly guided, coupled to the driven drive spindle, and rotationally fixed relative to the actuator housing. The actuating element includes a coupler arranged for releasably coupling to a shift fork.

### CROSS-REFERENCE TO RELATED APPLICATIONS

This application is the United States National Phase of PCT Appln. No. PCT/DE2024/100432 filed May 14, 2024, which claims priority to German Application No. DE 2023 114 556.8 filed Jun. 2, 2023, the entire disclosures of which are incorporated by reference herein.

### TECHNICAL FIELD

The present disclosure relates to a shift fork actuator including an actuator housing having a drive motor provided therein and a linear drive which is driven by the drive motor and comprises a rotationally driven drive spindle.

### BACKGROUND

Such a shift fork actuator is used to move a pivoting shift fork of a transmission, with the shift fork being, for example, part of a disconnect unit (DCU). Such a transmission or DCU is used, for example, in motor vehicles. A known shift fork actuator comprises a drive motor and a linear drive which can be driven by it and is coupled to the shift fork, which can be a linear shift fork or a pivoting shift fork. The drive motor and the linear drive are separate assemblies that are coupled to one another, with the linear drive, which is implemented, for example, as a ball screw drive, having a drive spindle that is to be mounted separately in the transmission housing, whereas the drive shaft of the drive motor is mounted in the motor housing. The two assemblies or sub-assemblies are connected to each other via a spline, so that torque transmission is possible. The structure of such a shift fork actuator and its integration in the transmission is therefore complex.

### SUMMARY

The present disclosure provides an improved shift fork actuator.

In a shift fork actuator of the type mentioned above, the present disclosure provides that the drive spindle is integral with a drive shaft of the drive motor, and the linear drive includes a linearly movable and linearly guided actuating element which is coupled to the drive spindle and which is rotationally fixed relative to the actuator housing and has the coupling means, or coupler, for releasable coupling to a shift fork.

The shift fork actuator according to the disclosure provides that the drive spindle and the drive shaft are a single, common component, i.e., that the motor-side drive shaft merges integrally into the drive spindle or has a corresponding spindle portion. This common component is machined from a corresponding shaft-type starting part, so that the corresponding portions are provided on it, i.e., a portion forming the drive shaft on the one hand and a portion forming the drive spindle on the other. Therefore, a separate connection of individual elements, as in the prior art, is unnecessary, as is a complex separate bearing system for the drive spindle.

Furthermore, the linear drive has a linearly movable and linearly guided actuating element which is coupled to the drive spindle and which is rotationally fixed relative to the actuator housing and has the coupling means for releasable coupling to a shift fork. The actuating element coupled to the drive spindle is moved linearly during a rotation of the drive spindle and is guided linearly on the drive spindle, so that a linear actuating movement on the part of the actuating element arises from the rotary shaft movement. The actuating element, in turn, is arranged in a rotationally fixed manner relative to the actuator housing of the actuator, meaning it cannot rotate about the longitudinal axis of the spindle, but retains its assumed rotational position once it has been installed. The actuating element, in turn, is provided with a corresponding coupling means that can be releasably coupled to the shift fork, i.e., brought into a mechanical connection via which the linear movement of the actuating element and thus of the coupling means can be transferred to the shift fork to effect the shifting process.

This design according to the present disclosure results, firstly, in a simple and compact structure of the shift fork actuator itself, since it can be pre-assembled with all its elements as a finished assembly. Therefore, during installation, only this one pre-assembled actuator needs to be installed on the transmission side. The installation is also simple, since it is only necessary to position the shift fork actuator and, in the meantime, bring the coupling means into operative connection to the shift fork. This can be achieved, for example, by moving the shift fork actuator in a first position onto the shift fork, and then rotating it into a second position, during which rotation the coupling means is automatically brought into operative connection to the shift fork and a mechanical coupling is effected, the shift fork actuator having assumed its final installation position in the second position. Due to the rotationally fixed arrangement of the actuating element relative to the actuator housing, and thus also the rotationally fixed arrangement of the coupling means relative to the actuator housing, the coupling means remains in the assumed, final coupling position, so that in the installation position there is a permanent connection of the shift fork actuator to the shift fork.

In a further development, it is possible for the actuating element to be designed as a sleeve in which the drive spindle engages and which is connected in a rotationally fixed manner via a form-fitting connection to the actuator housing or a component arranged on the actuator housing. The spindle operation therefore includes a simple sleeve as an actuating element, in which the drive spindle engages and to which it is coupled in such a way that, when the axially position-fixed drive spindle rotates, the linear displacement of the sleeve required for the shifting process takes place. The sleeve itself is connected in a rotationally fixed manner via a suitable form-fitting connection either to the actuator housing of the actuator itself or to a connecting component which is arranged in a rotationally fixed manner on the actuator housing and which complements the actuator housing, so that the rotationally secured sleeve guidance is ensured.

For coupling the sleeve to the drive spindle, the sleeve can have an internal thread and the drive spindle can have an external thread, and either the sleeve is coupled to the drive spindle via balls running in the internal and external threads or the internal thread meshes with the external thread. Consequently, the linear drive is a ball screw drive, in which the coupling of the drive spindle to the sleeve is realized via the balls disposed between them, which run in the threaded portions. Alternatively, a direct screw drive can also be implemented in which the two threaded portions of the drive spindle and the sleeve engage directly in one another.

In a further development, it is provided that the sleeve or a coupling component connected to the sleeve in a rotationally fixed manner has a longitudinal tooth system which engages in a longitudinal tooth system provided on the actuator housing or the component, the sleeve or the coupling component being guided in a rotationally fixed and linear manner via the toothed engagement. To achieve a rotationally fixed arrangement of the sleeve relative to the actuator housing, various designs are conceivable. A corresponding toothed engagement is implemented between two participating components, the toothed engagement being designed as a longitudinal tooth system according to this variant. For this purpose, the sleeve or a coupling component connected to the sleeve in a rotationally fixed manner can have a longitudinal tooth system, an internal longitudinal tooth system, which engages in a longitudinal tooth system, for example an external longitudinal tooth system, provided on the actuator housing or on the housing-side component. This toothed engagement creates a rotationally fixed linear guide.

Instead of forming such a toothed connection, it is also conceivable that at least one laterally protruding guide portion is provided on the sleeve or a coupling component connected to the sleeve in a rotationally fixed manner and engages in a guide groove or guide opening formed on the actuator housing or the component. The arrangement can, of course, also be reversed. According to this variant, a simple tongue-and-groove connection is realized, which forms the rotationally secured linear guide. Therefore, different designs for realizing the linear guide are conceivable.

If a tongue-and-groove connection is implemented using a guide portion and a guide groove, two guide portions protruding on opposite sides may be provided, each guide portion engaging in a guide groove or guide opening. Such a double-sided connection achieves a symmetrical double-sided guide.

To achieve the coupling to the shift fork, various coupling options are also conceivable. According to the present disclosure, the coupling means can be designed in the form of at least one laterally projecting coupling protrusion which engages between two coupling arms of the shift fork in the installation position, or a coupling receptacle into which one or each coupling protrusion provided on a coupling arm of the shift fork engages. According to a first variant, the coupling means is designed as a laterally protruding protrusion that engages between two coupling arms of the shift fork. This protrusion is inserted between the two coupling arms during installation, thereby creating the mechanical connection. Alternatively, it is conceivable that the coupling means has a corresponding coupling receptacle, i.e., a corresponding recess, in which one or each coupling protrusion provided on a coupling arm of the shift fork engages. The coupling mechanism is therefore reversed in this second variant, compared to the first variant. However, both designs allow for a simple mechanical connection, which can be formed in particular by simply rotating the shift fork actuator about the longitudinal axis of the drive shaft or drive spindle, during which rotation the coupling protrusion(s) is/are inserted into the corresponding receptacles.

In a further development, it is provided in this context that two coupling protrusions protruding on opposite sides are provided, which in the installation position each engage between two coupling arms of the shift fork, or that the coupling receptacle is designed as a circumferential groove in which the coupling projection(s) engage(s). According to the first alternative, two laterally projecting, wing-like coupling protrusions are provided, one of which engages in a corresponding receptacle between two coupling arms of the shift fork. According to the second alternative, the coupling receptacle forming the coupling means is designed as a simple circumferential annular groove in which the two protrusions provided on the shift fork engage.

In addition to the shift fork actuator itself, the present disclosure further relates to a transmission including at least one shift fork and at least one shift fork actuator of the type described above coupled to it.

### BRIEF DESCRIPTION OF THE DRAWINGS

The present disclosure is explained below on the basis of exemplary embodiments with reference to the drawings. The drawings are schematic representations, in which:

FIG. 1 shows a perspective schematic representation of a shift fork actuator coupled to a shift fork,

FIG. 2 shows a sectional view through the arrangement from FIG. 1,

FIG. 3 shows a frontal view of the arrangement from FIG. 1,

FIG. 4 shows a top view of the arrangement from FIG. 1,

FIG. 5 shows a perspective schematic representation of second embodiment of a shift fork actuator to be decoupled from a shift fork, and

FIG. 6 shows the arrangement from FIG. 5 while the mechanical coupling is effected.

### DETAILED DESCRIPTION

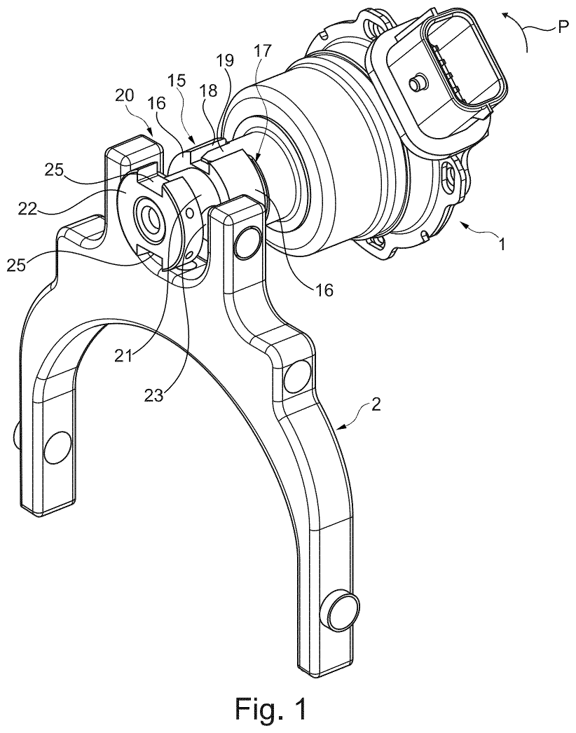

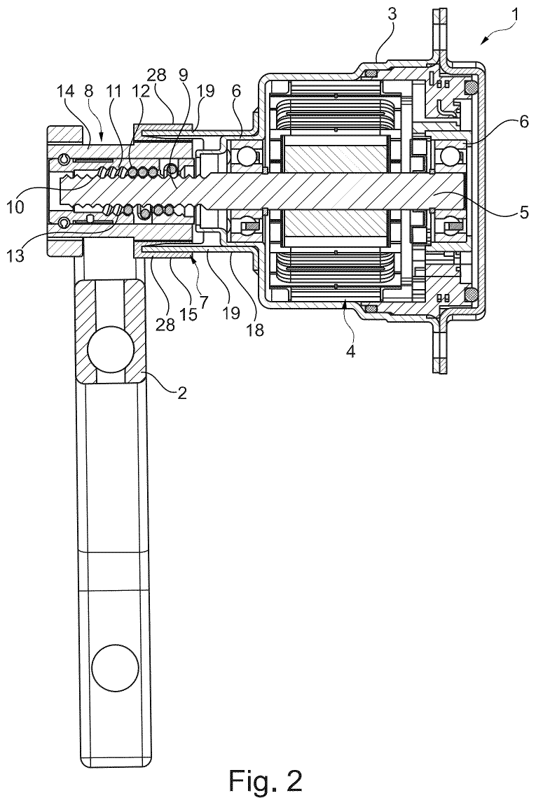

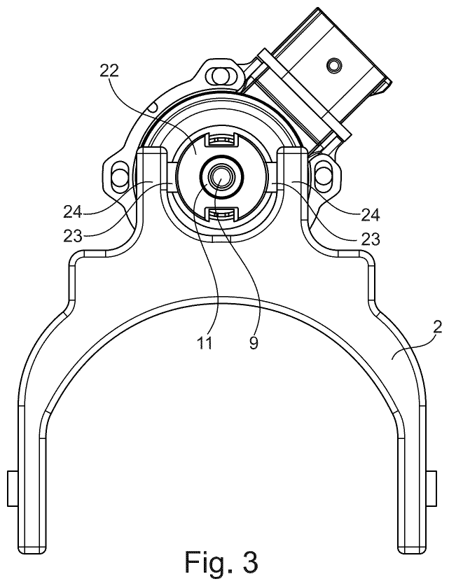

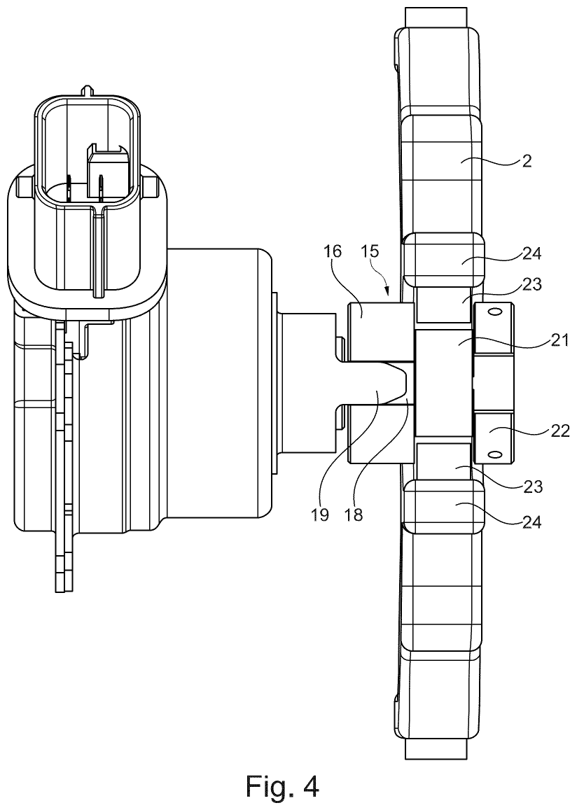

FIGS. 1-4 show a shift fork actuator 1 according to the present disclosure in a first embodiment, FIG. 1 showing a perspective view, FIG. 2 showing a longitudinal sectional view, and FIGS. 3 and 4 showing a front view and a top view respectively. The shift fork actuator 1 is shown in the installation position on a shift fork 2, which is designed as a pivoting shift fork and is incorporated together with the DCU in a transmission and secured by a pin which serves as the rotational axis for the shift fork 2. Next, the shift fork actuator 1 is installed. The installation is described below, but first the structure of the shift fork actuator 1 is discussed.

The shift fork actuator 1 includes an actuator housing 3, which may also be multi-part. A drive motor 4 is received in the actuator housing 3 and is an electric motor. Said motor includes a drive shaft 5, which can be driven rotationally. The drive shaft 5 is mounted in the actuator housing 3 by two bearing means 6, e.g., in the form of rolling bearings.

Furthermore, a linear drive 7 is provided, via which a linearly guided actuating element 8, which is coupled to the shift fork 2 in a suitable manner, can be moved linearly. The linear drive 7 has a drive spindle 9 which, as shown in the sectional view in FIG. 2, is formed integrally with the drive spindle 5, thus extending it. The drive spindle 9 has an external thread 10. Because it is integral with the drive shaft 5 and is already rotatably supported by two bearing means 6, the drive spindle 9 itself cannot be mounted separately.

The actuating element 8 is arranged on the drive spindle 9 and includes a sleeve 11 having an internal thread 12, the drive spindle 9 engaging in the sleeve 11. Balls 13 are arranged between the two and run in the corresponding threads 10, 12. The linear drive 7 is therefore a ball screw drive. A rotation of the position-fixed drive shaft 5 consequently leads to a rotation of the inevitably also position-fixed drive spindle 9, wherein, depending on the direction of rotation, the sleeve 11 is displaced linearly along the drive spindle 9 by the coupling of the sleeve 11 via the balls 12. As a result of the coupling of the sleeve 11 to the shift fork 2, which coupling is described below, a corresponding linear actuating movement is transferred to the shift fork 2, causing it to pivot accordingly.

The sleeve 11 has a coupling component 14, which is also designed in the form of a sleeve into which the sleeve 11 is inserted and with which it is connected. The sleeve-type coupling component 14 has, on one side, a coupling portion 15 which has two laterally protruding guide portions 16 which engage in corresponding guide grooves 17 on a component 18 which is a fixed part of the actuator housing 3. Ultimately, the coupling component 14 has two longitudinal grooves 28 on the coupling portion 15, into which grooves a protruding arm 19 of the component 18 engages. This results in an anti-rotation device that also allows a linear displacement of the coupling component 14 together with the sleeve 11 relative to the actuator housing 3.

Furthermore, a suitable coupling means, or coupler, 20 is provided on the coupling component 14 and serves for mechanical connection to the shift fork 2. The coupling means 20 is designed here as a coupling receptacle 21, which in the example is designed as a circumferential groove. The groove-like coupling receptacle 21 is axially delimited towards the drive motor 2 via the coupling portions 15, and on the other side via an end flange 22. On the shift fork 2, two coupling protrusions 23 are arranged on corresponding coupling arms 24 of the shift fork 2, which engage in the groove-like coupling receptacle 21, as FIG. 1 as well as FIGS. 3 and 4 clearly show. Furthermore, two radial recesses 25 are formed on the end flange 22, which are dimensioned such that the two coupling protrusions 23 can be guided through the recesses 25 during installation.

The result is an overall structure that is compact, since ultimately the linear guide 7 is arranged directly on the drive motor 4 and, in particular, the drive shaft 5 is integrally formed with the drive spindle 9. There is also a rotationally secured, linearly guided coupling between the actuating element 8 relative to the actuator housing 3, and corresponding coupling means 20 for a simple mechanical connection to the shift fork 2 are provided on the actuating element 8 via the coupling component 14.

During installation, the shift fork actuator 1 is first positioned such that the two recesses 25 are positioned virtually in axial extension of the two coupling protrusions 23. Starting from FIG. 1, the shift fork actuator 1 would be rotated 90° to the left, as shown by the arrow P. The shift fork actuator positioned in this way is displaced until the two coupling protrusions 23 are adjacent to the coupling receptacle 21, after which the shift fork actuator 1 is rotated 90° into the installation position shown in FIG. 1, in which the coupling protrusions 23 are received in the groove-like coupling receptacle 21 in a manner blocked in both axial directions. The groove-like coupling receptacle 21 is axially delimited by the corresponding shoulders of the two guide portions 16, i.e., the coupling portion 15 on the one side and the end flange 22 on the other side. In this position, the shift fork actuator 1 is now firmly fixed to the transmission side, usually by screwing. As part of its actuating function, the drive spindle 9 is rotated by activating the drive motor 4, which leads to a longitudinal displacement of the actuating element 8, but in a rotationally secured and linearly guided manner, and, depending on the direction of rotation, the actuating element 8 moves in one direction or the other along the drive spindle 9, thereby carrying and pivoting the shift fork 2 accordingly.

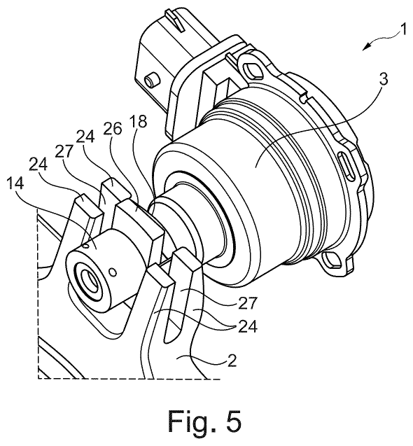

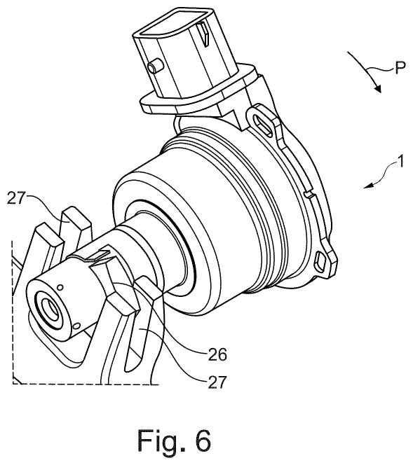

FIGS. 5 and 6 show a further embodiment of a shift fork actuator 1, in which the same reference signs are used for comparable components. In this case also, an actuator housing 3 is provided, in which a drive motor (not shown in detail) is received. The basic structure corresponds to that described for FIGS. 1-4.

In this case also, a sleeve-type coupling component 14 is provided, in which the sleeve 11 is received and which is connected to the sleeve 8. The rotationally fixed arrangement of the coupling component 14 relative to the actuator housing 3 can be implemented in a similar manner to that described in FIGS. 1-4. Alternatively, the sleeve-type coupling component 14 can also have an external longitudinal tooth system, while the component 18, which is fixedly connected to the actuator housing 3, has an internal longitudinal tooth system, which provides the anti-rotation device on the one hand and the linear guide on the other.

In this embodiment, the sleeve has two wing-like coupling protrusions 26 that project laterally on opposite sides. The shift fork 2 has a pair of coupling arms 24 on each of the two sides, between which coupling arms a coupling receptacle 27 is formed, into which a wing-like coupling protrusion 26 is to be inserted. FIG. 5 shows the arrangement during installation. The shift fork actuator 1 is rotated such that the two coupling protrusions 25 can be moved between the two coupling arm pairs. In this position shown in FIG. 5, the rotational movement then begins, which is partially shown in FIG. 6, and during which the entire shift fork actuator 1, as indicated by the arrow P, is again rotated by 90° into the end position (not shown in detail). In this process, the two wing-like coupling protrusions 26 are inserted into the respective coupling receptacles 27 and an axially fixed coupling is achieved. In the installation position, the shift fork actuator 1 is also rotated by 90° compared to the position shown in FIG. 5 and can be fixedly installed in the end position on the transmission side.

The shift fork actuator 1 according to the disclosure can also be disassembled in an equally simple manner if required. To do this, it is only necessary to release its connection to the transmission or transmission housing, after which it can be released from its coupling to the shift fork 2 and removed by simply rotating it 90°.

### REFERENCE NUMERALS

2 Shift fork
1 Shift fork actuator
3 Actuator housing
4 Drive motor
5 Drive shaft
6 Bearing means
7 Linear drive
8 Actuating element
9 Drive spindle
10 External thread
11 Sleeve
12 Internal thread
13 Ball
14 Coupling component
15 Coupling portion
16 Guide portion
17 Guide groove
18 Component
19 Arm
20 Coupling means or coupler
21 Coupling receptacle
22 End flange
23 Coupling protrusion
24 Coupling arm
25 Recess
26 Coupling protrusion
27 Coupling receptacle
28 Longitudinal groove
P Arrow

1. A shift fork actuator comprising an actuator housing with a drive motor provided therein and a linear drive which is driven via the drive motor and comprises a rotationally driven drive spindle, wherein the drive spindle is integral with a drive shaft of the drive motor, and the linear drive has a linearly movable and linearly guided actuating element which is coupled to the drive spindle and which is rotationally fixed relative to the actuator housing and has a coupler for releasable coupling to a shift fork.

2. The shift fork actuator according to claim 1, wherein the actuating element is designed as or comprises a sleeve in which the drive spindle engages and which is connected to the actuator housing or to a component arranged on the actuator housing in a rotationally fixed manner via a form-fitting connection.

3. The shift fork actuator according to claim 2, wherein the sleeve has an internal thread and the drive spindle has an external thread, either the sleeve being coupled to the drive spindle via balls running in the internal and external threads or the internal thread meshing with the external thread.

4. The shift fork actuator according to claim 2, wherein the sleeve or a coupling component connected to the sleeve in a rotationally fixed manner has a longitudinal tooth system which engages in a longitudinal tooth system provided on the actuator housing or the component, the sleeve or the coupling component being guided in a rotationally fixed and linear manner via the toothed engagement.

5. The shift fork actuator according to claim 2, wherein at least one laterally protruding guide portion is provided on the sleeve or on a coupling component connected to the sleeve in a rotationally fixed manner and engages in a guide groove or guide opening formed on the actuator housing or the component.

6. The shift fork actuator according to claim 5, wherein two guide portions protruding on opposite sides are provided and each engage in a respective guide groove or guide opening.

7. The shift fork actuator according to claim 1, wherein the coupler is designed in the form of at least one coupling protrusion, which projects laterally from the actuating element and which in an installation position engages between two coupling arms of the shift fork, or a coupling receptacle in which one or each coupling protrusion provided on a coupling arm of the shift fork engages.

8. The shift fork actuator according to claim 7, wherein two coupling protrusions protruding on opposite sides are provided and in the installation position each engage between two coupling arms of the shift fork or the coupling receptacle is designed as a circumferential groove in which the coupling protrusion(s) engage(s).

9. A transmission comprising at least one shift fork and at least one shift fork actuator coupled to said shift fork according to claim 1.

10. A shift fork actuator comprising:
an actuator housing;
a drive motor provided in the actuator housing; and
a linear drive driven by the drive motor, the linear drive comprising:
a drive shaft;
a driven drive spindle integral with the drive shaft; and
an actuating element:
linearly moveable and linearly guided;
coupled to the driven drive spindle and rotationally fixed relative to the actuator housing; and
comprising a coupler arranged for releasably coupling to a shift fork.

11. The shift fork actuator of claim 10, wherein:
the actuating element comprises a sleeve rotationally fixed to the actuator housing via a form-fitting connection; and
the driven drive spindle engages the sleeve.

12. The shift fork actuator of claim 11, wherein:
the sleeve comprises an internal thread;
the driven drive spindle comprises an external thread; and
the shift fork actuator further comprises balls running in the internal thread and the external thread to couple the sleeve to the driven drive spindle; or
the internal thread meshes with the external thread to couple the sleeve to the driven drive spindle.

13. The shift fork actuator of claim 11, wherein:
the actuator housing comprises a housing longitudinal tooth system; and
the sleeve comprises a sleeve longitudinal tooth system engaged with the housing longitudinal tooth system to guide the sleeve in a rotationally fixed and linear manner via toothed engagement.

14. The shift fork actuator of claim 11, wherein:
the actuator housing comprises a first groove; and
the sleeve comprises a first laterally protruding guide portion engaged in the first groove.

15. The shift fork actuator of claim 14, wherein:
the actuator housing comprises a second groove; and
the sleeve comprises a second laterally protruding guide portion, opposite the first laterally protruding guide portion, engaged in the second groove.

16. The shift fork actuator of claim 10, further comprising the shift fork, wherein:
the shift fork comprises a first coupling arm; and
the coupler comprises a first coupling protrusion projecting laterally from the actuating element and engaging the first coupling arm in an installation position.

17. The shift fork actuator of claim 16, wherein:
the shift fork comprises a second coupling arm; and
the coupler comprises a second coupling protrusion projecting laterally from the actuating element and engaging the second coupling arm in the installation position.

18. The shift fork actuator of claim 10, further comprising the shift fork, wherein:
the coupler comprises a receptacle; and
the shift fork comprises a first coupling arm having a first coupling protrusion engaging the receptacle in an installation position.

19. The shift fork actuator of claim 18, wherein:
the receptacle is arranged as a circumferential groove;
the shift fork comprises a second coupling arm having a second coupling protrusion; and
the first coupling protrusion and the second coupling protrusion are engaged with the circumferential groove in the installation position.

20. A transmission comprising:
the shift fork actuator of claim 10; and
the shift fork coupled to the shift fork actuator.
